(19) United States
(12) Patent Application Publication
(10) Pub. No.: US 2017/0178077 A1
(43) Pub. Date: Jun. 22, 2017

(54) INFORMATION PROCESSING APPARATUS, INFORMATION PROCESSING METHOD, AND INFORMATION PROCESSING SYSTEM

(71) Applicants: Hiroshi INABA, Tokyo (JP); Yoshihiro NAGASHIMA, Chiba (JP); Hirotoshi INOO, Tokyo (JP)

(72) Inventors: Hiroshi INABA, Tokyo (JP); Yoshihiro NAGASHIMA, Chiba (JP); Hirotoshi INOO, Tokyo (JP)

(73) Assignee: Ricoh Company, Ltd., Tokyo (JP)

(21) Appl. No.: 15/310,160

(22) PCT Filed: Jun. 9, 2015
(86) PCT No.: PCT/IB2015/000885

§ 371 Date: Nov. 10, 2016

(30) Foreign Application Priority Data
Jun. 2, 2014 (JP) 2014-114309
Jul. 11, 2014 (JP) 2014-143238

(51) Int. Cl. G06Q 10/10; G06K 9/00; G06K 9/18

(52) U.S. Cl. CPC G06Q 10/105; G06K 9/18; G06K 9/00885

(57) ABSTRACT

An information processing apparatus is included in an information processing system including a name card reading apparatus and the information processing apparatus connected therebetween. The information processing apparatus includes: a memory unit storing information of divisions of an organization and information of persons belonging to the divisions acquired from the name card reading, apparatus; an acquisition unit acquiring information of persons belonging to respective divisions in the organization from another medium; an identification unit identifying information of the person not stored in the memory unit from the information of the persons acquired by the acquisition unit; and an output unit outputting the identified information of the person.

### TECHNICAL FIELD

The present invention relates to an information processing apparatus, an information processing method, and an information processing system.

### BACKGROUND ART

There has been known a name card management system which optically reads a character string written on a name card by using an Optical Character Recognition (OCR) process, and manages the acquired information. Such a name card management system can manage division name of the organization in association with the name of the person belonging to the division based on the description on the name card.

Patent Document 1 discloses a name card OCR processing system which reads a name card by an OCR process, and stores the information acquired by the reading in a database on a name card basis, so that the information can be corrected, modified, or deleted upon receiving a request.

Patent Document 2 discloses a system which generates and manages name card management data by acquiring an image of plural name cards simultaneously to acquire images and the information on a name card basis, so that the name cards can be managed on a page basis based on the acquired image and information.

### SUMMARY OF THE INVENTION

### Problems to be Solved by the Invention

There exists a request to effectively use the information stored in a name card management system in business activities. For example, based on a division name described on one name card, it is possible to know the existence of a higher division: Therefore, for example, when a person belonging to the division is known, it becomes possible to contact the person.

However, based on a conventional name card management system, it is not possible to manage the information of a non-contact person. Therefore, even when a higher division is known, it is not possible to identify a person who belongs to the division.

Further, based on a conventional name card management system, it is not possible to recognize the existence of a division which is not described in a name card (i.e., a division other than a higher division). Thus, even though it is possible to seemingly visualize a progress of sales activities, it is difficult to visualize substantive progress which indicates, for example, whether there exists any division having a potential to be a more important contact and whether a person belonging to the division is already in contact.

The present invention is made in light of the problem, and an object of the present invention is to make it possible to visualize more effective information based on name card reception information.

### Means for Solving the Problems

According to an aspect of the present invention, an information processing apparatus is included in an information processing system including a name card reading apparatus and the information processing apparatus connected therebetween. The information processing apparatus includes: a memory unit storing information of divisions of an organization and information of persons belonging to the divisions acquired from the name card reading apparatus; an acquisition unit acquiring information of persons belonging to respective divisions in the organization from another medium; an identification unit identifying information of the person who is not stored in the memory unit from the information of the persons acquired by the acquisition unit; and an output unit outputting the identified information of the person.

### Effects of the Present Invention

According to an aspect of the present invention, it becomes possible to conduct sales activities more effectively based on name card reception information.

### BRIEF DESCRIPTION OF THE DRAWINGS

FIG. 1 is a schematic view of a system according one embodiment of the present invention;

FIG. 2 is a hardware configuration diagram of an information processing apparatus according to an embodiment of the present invention;

FIG. 3 is a functional block diagram of the information processing apparatus according to an embodiment of the present invention;

FIG. 4 is a detailed functional block diagram of the information processing apparatus according to an embodiment of the present invention;

FIG. 5 is an example of an employee information management table storing employee information;

FIG. 6 is an example of an employee history information management table storing employee history information;

FIG. 7 is an example of an organization information management table storing organization information;

FIG. 8 is an example of an achievement level information management table storing achievement level information;

FIG. 9 is an example organization chart generated based on the information acquired by reading name cards;

FIG. 10 illustrates example information which is acquired externally;

FIG. 11 is an example organization chart generated based on the information which is acquired externally;

FIG. 12 illustrates another example of the information which is provided externally;

FIG. 13 is another example of the organization chart generated based on the information which is provided externally;

FIG. 14 illustrates an example of the employee information management table which is updated based on external information;

FIG. 15 illustrates an example of the organization information management table which is updated based on external information;

FIG. 16 illustrates an example of the achievement level information management table which is updated based on external information;

FIG. 17 is an example organization chart generated based on the information which is updated based on external information;

FIG. 18 illustrates an example of an information display screen to support sales activities;

FIG. 19 illustrates another example of the information display screen to support sales activities;

FIG. 20 illustrates still another example of the information display screen to support sales activities;

FIG. 21 is a flowchart of an external information acquisition process performed by the information processing apparatus according to an embodiment of the present invention;

FIG. 22 is a flowchart of an achievement level calculation process performed by the information processing apparatus according to an embodiment of the present invention;

FIG. 23 is a flowchart of an example operation performed by the information processing apparatus according to an embodiment of the present invention; and

FIG. 24 is a schematic view of another system according one embodiment of the present invention.

### BEST MODE FOR CARRYING OUT THE INVENTION

In the following, embodiments of the present invention are described with reference to the accompanying drawings.

### 1. System

2. Hardware configuration

### 3. Functions

4. Example operations

External information acquisition process

Achievement level calculation process

Specific example of operation

### 5. Effect

### 1. System

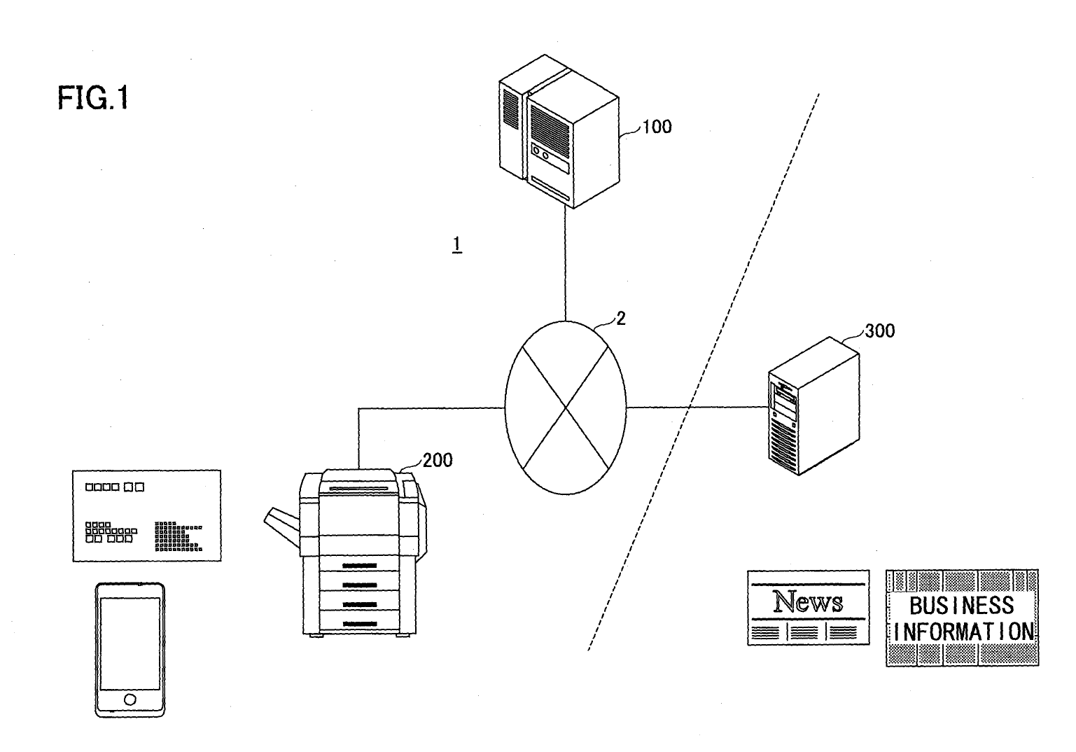

FIG. 1 schematically illustrates a system 1 according to an embodiment of the present invention. The system 1 includes an information processing apparatus 100, which manages information of name cards, a name card reading apparatus 200, which reads a paper medium such as a name card, and an information providing apparatus 300 which provides information for investors and personnel information with an electronic medium. The information processing apparatus 100, the name card reading apparatus 200, and the information providing apparatus 300 are connected to each other via a network 2.

The information processing apparatus 100 manages the information which is acquired by the name card reading apparatus 200 by reading a name card. The information acquired from a name card includes a name of a person and a name of a division to which the person belongs. Here, the name of the division includes names of one or more divisions, which are included in a hierarchical organization, such as generally-known “department”, “section”, “group”, etc. Therefore, the information processing apparatus 100 can manage the information of plural divisions acquired from a name card of a single person.

Based on the information read from a name card, the information processing apparatus 100 can configure (generate) an organization chart. Based on the information acquired from a name card alone, although the information processing apparatus 100 can identify the division name, the information processing apparatus 100 cannot identify a name of the person (responsible person) who manages the division (e.g., a name of a general manager of a general affairs department). Furthermore, the information processing apparatus 100 cannot identify a division which is not described in the name card nor a person who manages the division.

Actually, a person in charge of sales have received a name card. That is, the person wishes to conduct sales activity with the responsible person who is other than a person in actual contact. In response to such a desire, the information processing apparatus 100 can acquire information for investors and personnel information which are provided by paper medium or the external information providing apparatus 300.

Generally, the information for investors and the personnel information disclose names of persons with higher titles such as representative, director, general manager, etc. The information processing apparatus 100 acquires such information and updates the information under management based on the acquired information. By doing this, it becomes possible for the information processing apparatus 100 to acquire, for example, a name of the general manager of the general affairs department which was unknown, a counting section whose existence was unknown, and a name of the responsible person of the counting section.

The information processing apparatus 100 sends a report of the name of the person that is clarified based on the information which is externally acquired, so that it becomes possible to clarify the target with whom sales activity is to be conducted. As a result, it becomes possible to effectively support the sales activities by the person in charge of sales.

Further, an image of a name card is captured by any image reading apparatus such as a Multifunction Peripheral (MFP), a smartphone, a camera, or the like. Further, the information processing apparatus 100 may be formed by plural information processing apparatuses 100-1 through 100-n.

### 2. Hardware Configuration

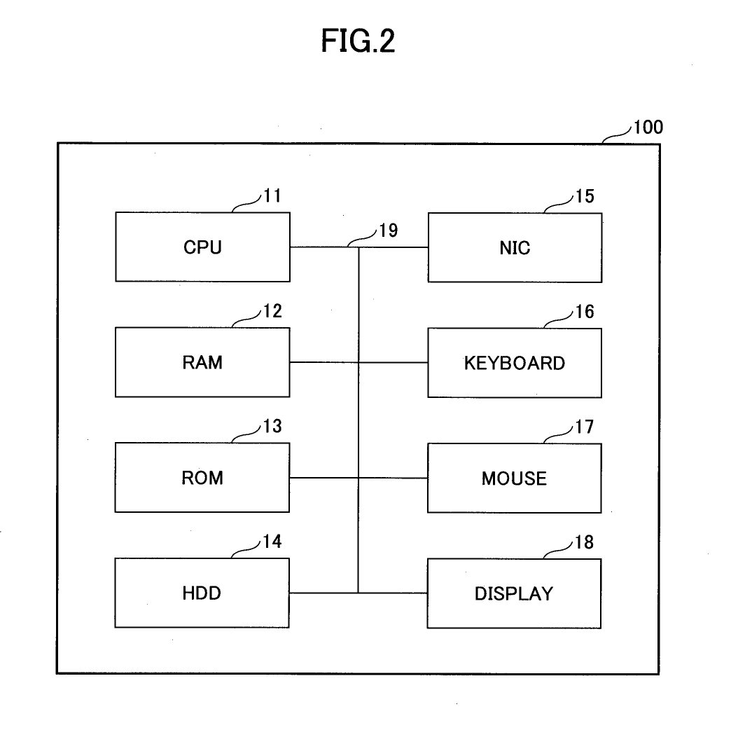

FIG. 2 is a hardware configuration diagram of the information processing apparatus 100 according to an embodiment of the present invention. The information processing apparatus 100 includes a Central Processing Unit (CPU) 11, a Random Access Memory (RAM) 12, a Read-Only Memory (ROM) 13, a Hard Disk Drive (HDD) 14, a Network Interface Card (NIC) 15, a keyboard 16, a mouse 17, and a display 18.

The CPU 11 executes a program to perform operation control of the information processing apparatus 100. The RAM 12 provides a working area for the CPU 11. The ROM 13 stores a system program to start up the information processing apparatus 100. The HDD 14 stores an Operating System (OS) to manage the operations of the information processing apparatus 100 and the data which are necessary for the operations of the OS. The HDD 14 further stores the information which is read from a name card and the information which is acquired externally.

The NIC 15 is used to connect to a Local Area Network (LAN). The keyboard 16 and the mouse 17 are devices to receive input from a manager of the information processing apparatus 100, etc. The display 18 is a device to display information to the manager of the information processing apparatus 100. Those elements (devices) are electrically connected to each other via a bus 19.

Further, the information processing apparatus 100 may function as a server, so as to input and output information from and to a client connected thereto via a network. In this case, the information processing apparatus 100 may exclude the keyboard 16, the mouse 17, and the display 18.

Further, the information processing apparatus 100 may have a single chassis or may include multiple of them. For example, the information processing apparatus 100 may a storage area on a network in place of the HDD 14.

### 3. Functions

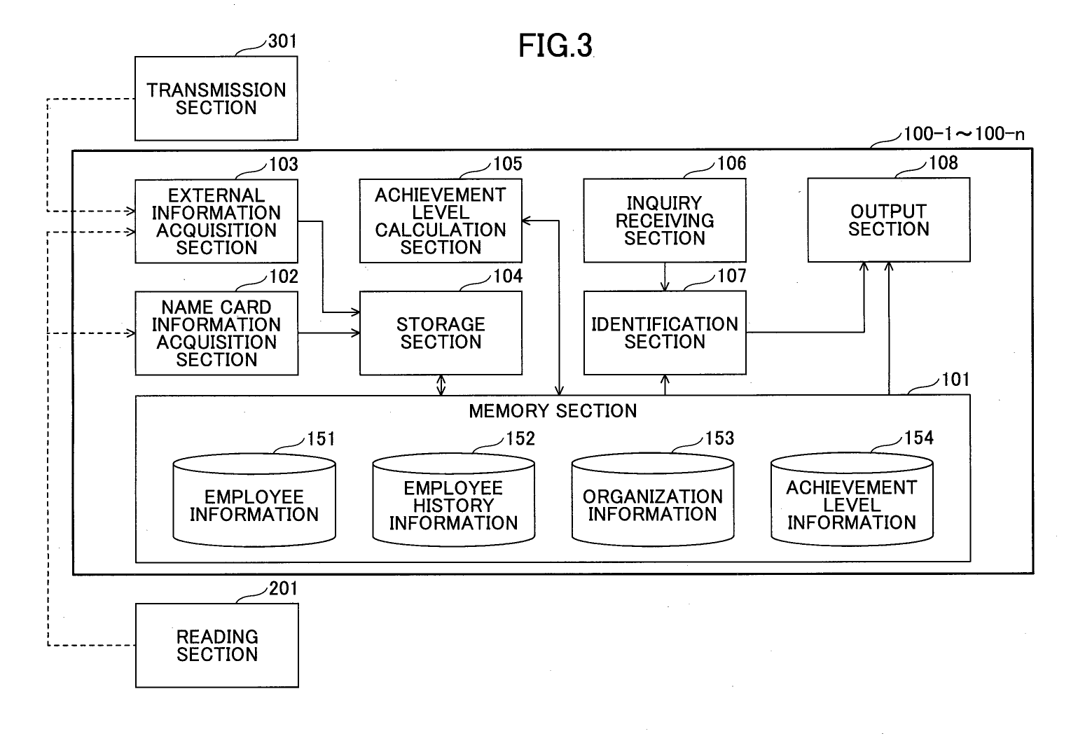

FIG. 3 is a functional block diagram of the information processing apparatus 100 (or the information processing apparatuses 100-1 through 100-n) according to an embodiment of the present invention. The information processing apparatus 100 includes a memory section 101, a name card information acquisition section 102, an external information acquisition section 103, a storage section 104, an achievement level calculation section 105, an inquiry receiving section 106, an identification section 107, and an output section 108.

The memory section 101 is realized by the HDD 14 of FIG. 2, and stores employee information 151, employee history information 152, organization information 153, and achievement level information 154.

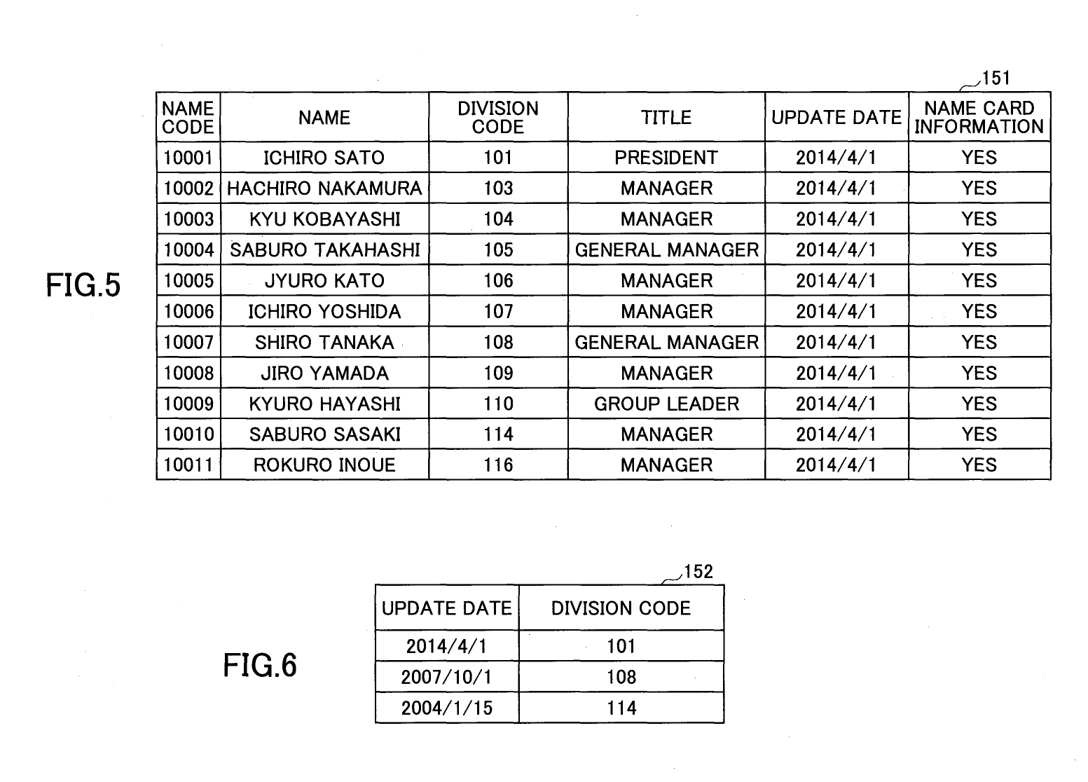

The employee information 151 includes, for example, a name of an employee in association with a division name to which the employee belongs. FIG. 5 illustrates an example of an employee information management table storing the employee information 151. As illustrated in FIG. 5, the employee information management table includes items which are name code, name, division code, title, update date, and name card reception information.

The name code is an identifier corresponding to an employee. The name refers to the name of the employee. The division code refer to the code of the division to which the employee belongs. The title refers to the tile of the employee in the division. The update date refer to the latest date when any of the information related to the employee has been updated. The name card reception information indicates whether the name card of the employee has been received or not. The data “YES” indicates that the name card of the employee has been received, and the data “NO” indicates that the name card has not been received yet.

Here, the term “employee” is used. Note that, however, the information to be stored is not limited the information of an employee, and any information of a person who belongs to the organization may also be stored.

The employee history information 152 includes, for example, the information of the divisions that the employee has ever belonged to and currently belongs to (history of the divisions). FIG. 6 is an example of an employee history information management table storing the employee history information 152 of one employee, “Ichiro Sato”. As illustrated, the employee history information management table may be provided on an employee basis. Further, as illustrated in FIG. 6, the employee history information management table includes items which are update date and division code.

The update date is the date when it has been clarified that the employee belongs to the division of the division code. Further, the division code corresponding to the latest update date indicates the division to which the employee currently belongs.

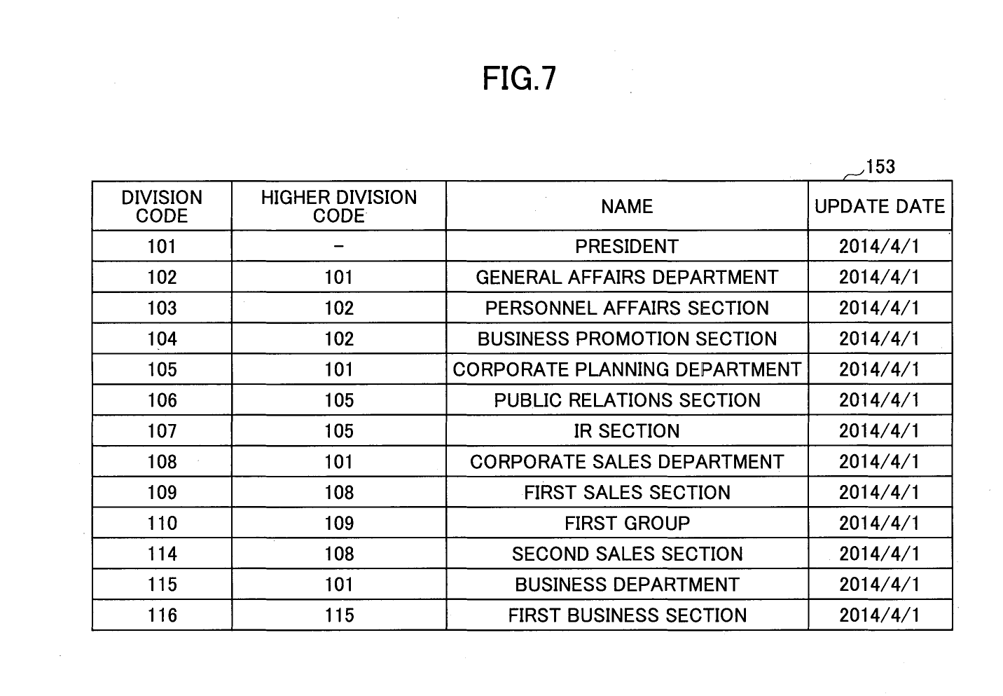

The organization information 153 indicates a structure of the organization including one or more divisions. FIG. 7 illustrates an example of an organization information management table storing the organization information 153. As illustrated in FIG. 7, the organization information management table includes items which are division code, higher division code, name, and update date.

The division code is an identifier corresponding to the division. The higher division code is an identifier (division code) of a higher division which is higher than the division in the organization. When such a higher division does not exist (or unknown), data “-” is stored. The name refers to the name of the division. The update date refers to the last date when the any of the information related to the division has been updated.

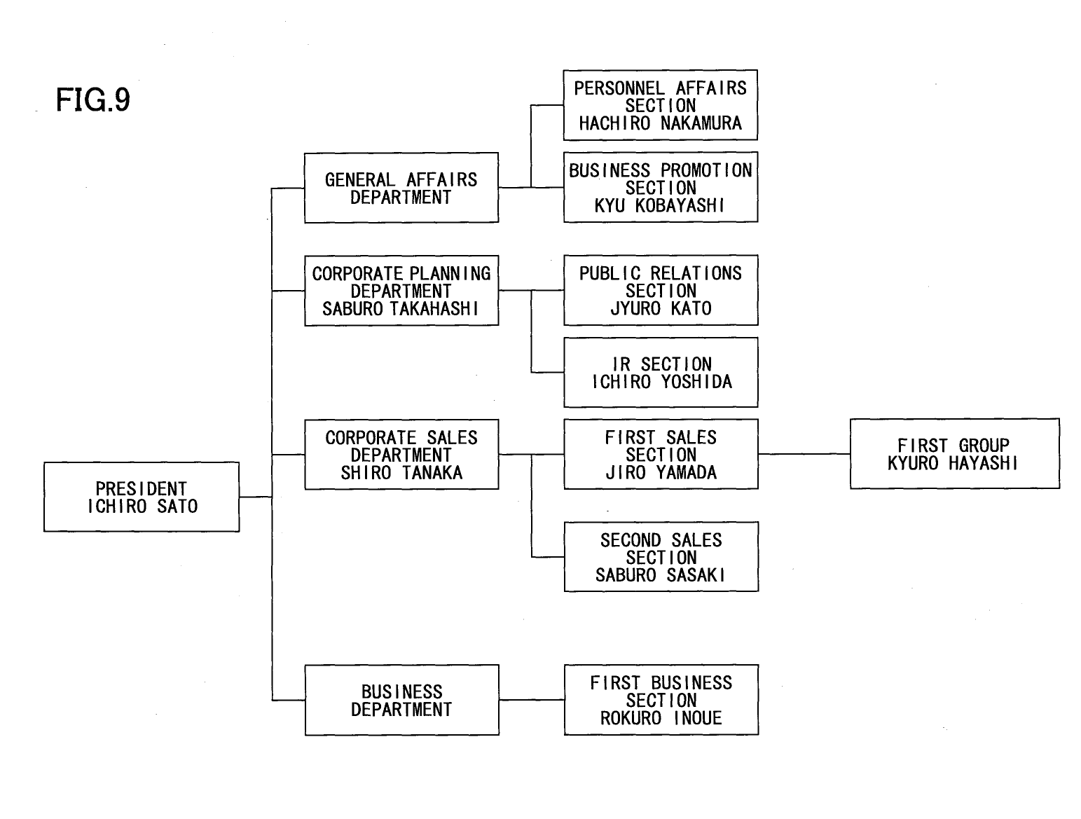

FIG. 9 is the organization chart generated based on the employee information 151 of FIG. 5 and the organization information 153 of FIG. 7. As illustrated in FIG. 9, although the existence of the “general affairs department” and the “business department” is clarified, the names of the employees who are the responsible persons of those departments are not clear (unknown).

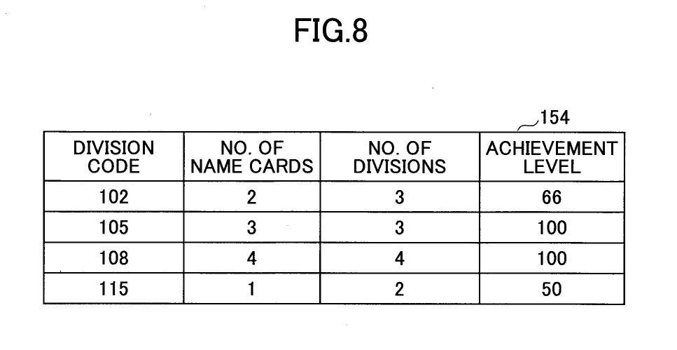

The achievement level information 154 indicates the achievement level of the sales activities to predetermined specific divisions. FIG. 8 is an example of an achievement level information management table storing achievement level information 154. As illustrated in FIG. 8, the achievement level information management table includes items which are division code, number of name cards, number of divisions, and achievement level.

The division code refers to the code of the division which is determined by, for example, the manager and which is the target when the achievement level, described below, is estimated. The number of name cards refers to the number of the name cards that have actually been received from the employees who belong to the division or a division lower than the division in the organization. The number of name cards is calculated based on the data of the name card reception information of FIG. 5. The number of divisions refers to the number of divisions including the division and lower divisions which are (directly) lower than the division in the organization. The number of divisions is calculated based on the numbers of the division codes and the higher division codes of FIG. 7.

The achievement level refers to a value calculated by rounding a value calculated by dividing the number of name cards by the number of divisions and multiplying the rounded value by 100. In this case, the achievement level indicates a ratio of the number of acquired name cards to a specific scale of divisions, which represents the progress of the sales activities thereto. Note that, however, the calculation method of the achievement level is not limited thereto. That is, the achievement level may be calculated by any appropriate method. For example, the achievement level may be calculated based on a ratio of the number of name cards to the number of employees belonging to the corresponding divisions.

The name card information acquisition section 102 is realized mainly by processes performed by the CPU 11 or the NIC 15 of FIG. 2, and acquires the information which is acquired by reading a name card by a reading section 201 of the name card reading apparatus 200. Based on the acquired information, the name card information acquisition section 102 can acquire a set of one or more division names and the names and the titles of the persons. Here, the “set of one or more division names” refers to not only the names of the divisions (e.g., “corporate sales department”, “first sales section”, and “first group”) but also the hierarchical structure therebetween. The name card information acquisition section 102 stores the acquired information in the storage section 104.

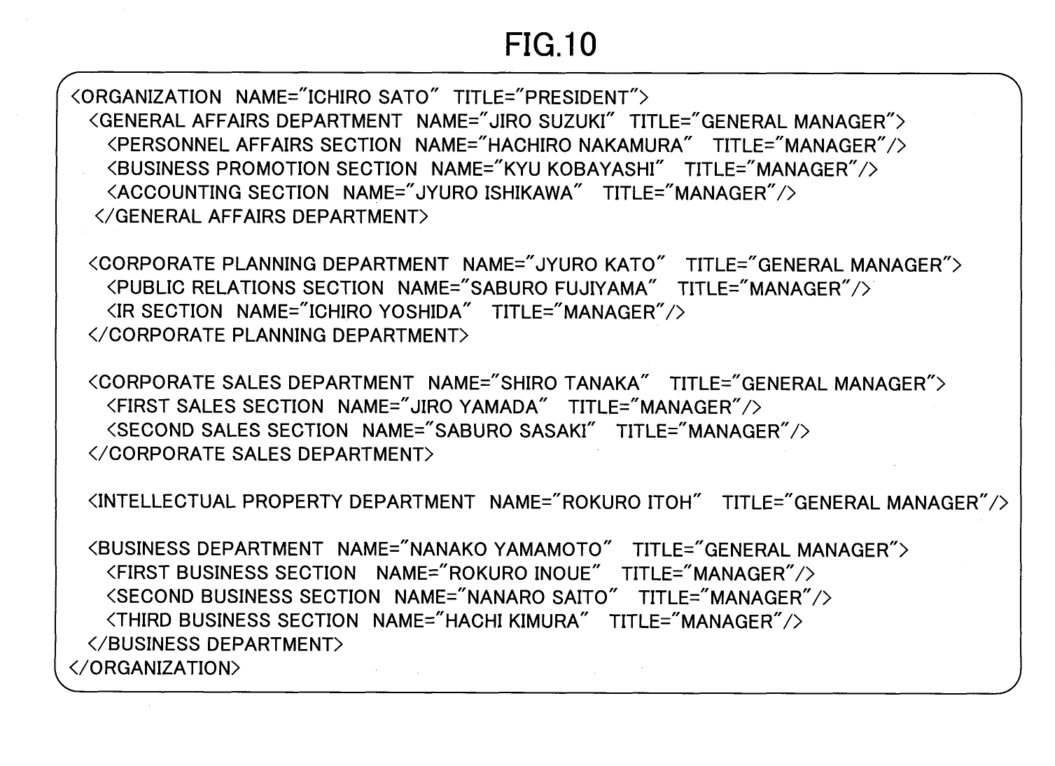

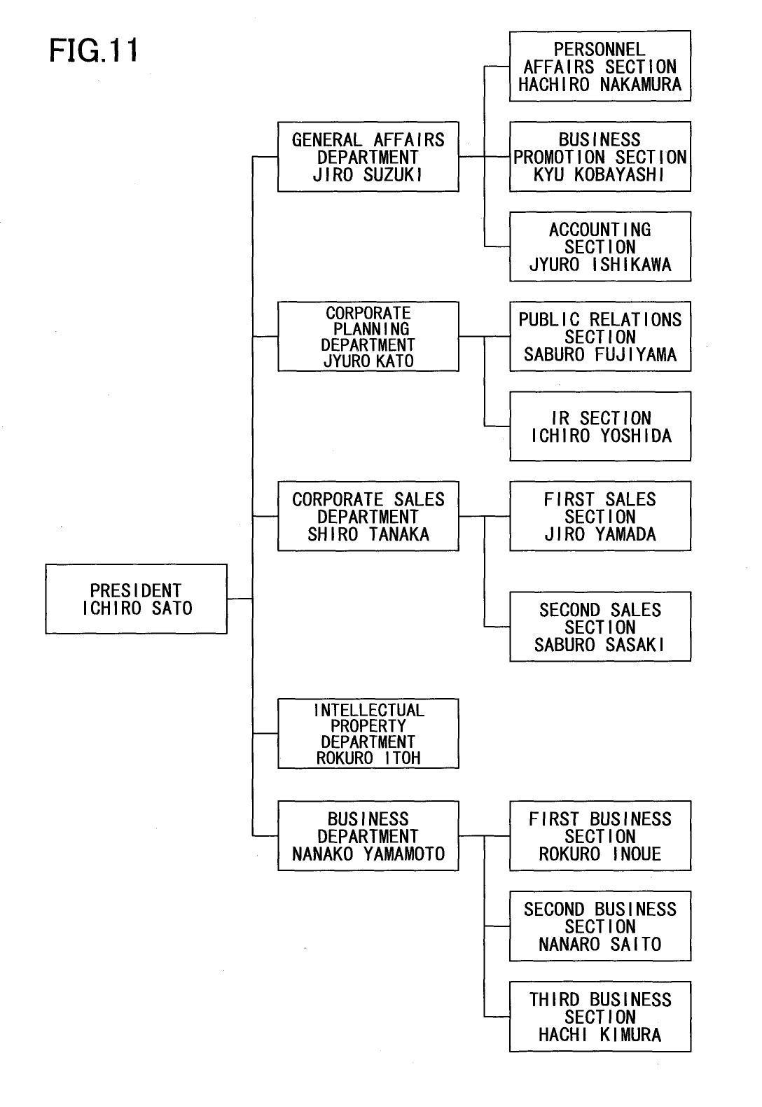

The external information acquisition section 103 is realized mainly by the processes performed by the CPU 11 or the NIC 15 of FIG. 2, and acquires external information such as, for example, the information for investors and the personnel information transmitted from a transmission section 301 of the information providing apparatus 300. Similar to the information described in a name card, the external information includes a set of one or more division names and the names and the titles of the persons. FIG. 10 illustrates an example of the external information in an Extensible Markup Language (XML) format acquired by the external information acquisition section 103. The external information of FIG. 10 corresponds to the organization chart of FIG. 11. The external information acquisition section 103 transmits the acquired information to the storage section 104.

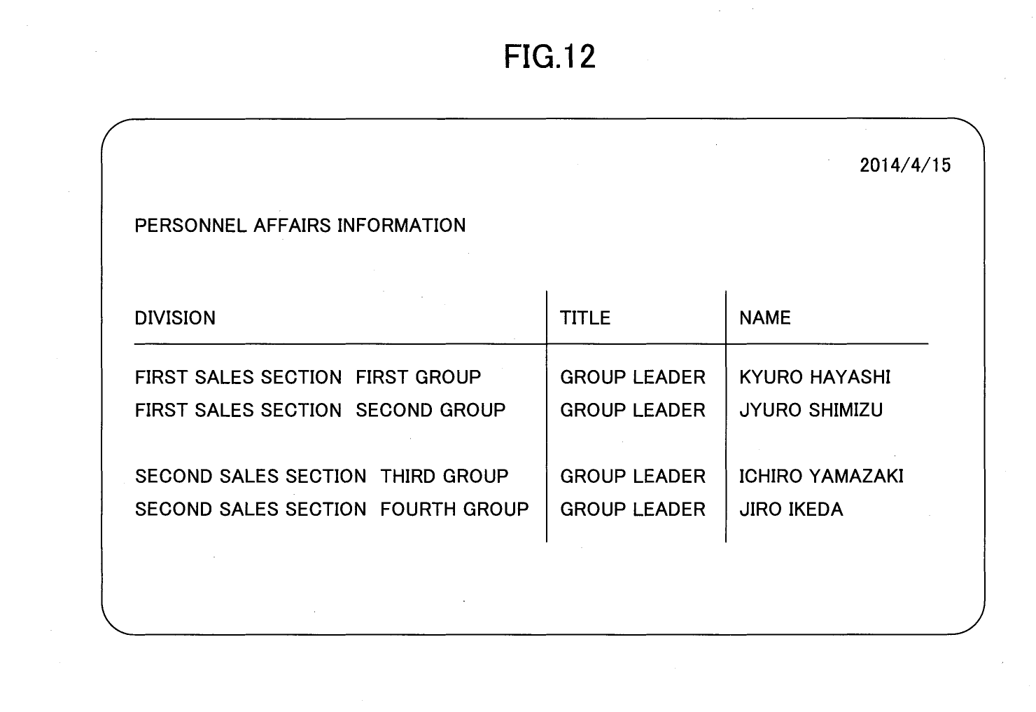

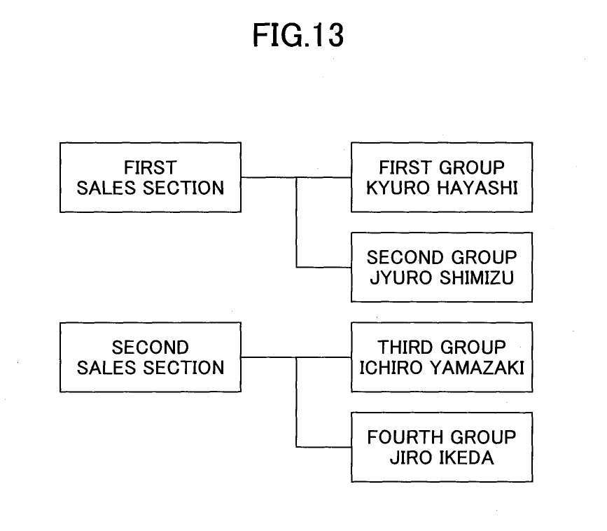

The external information acquisition section 103 may acquire the external information which is acquired by reading a paper medium (e.g., a newspaper, a book, a distributed document) by the reading section 201 of the name card reading apparatus 200. FIG. 12 illustrates an example of the external information provided by a paper medium and acquired by the external information acquisition section 103. The external information acquisition section 103 can acquire the external information which has been digitized by an OCR process. The external information of FIG. 12 corresponds to the organization chart of FIG. 13.

The storage section 104 is realized mainly by the processes performed by the CPU 11 of FIG. 2, and stores the information received from the name card information acquisition section 102 or the external information acquisition section 103 in the memory section 101.

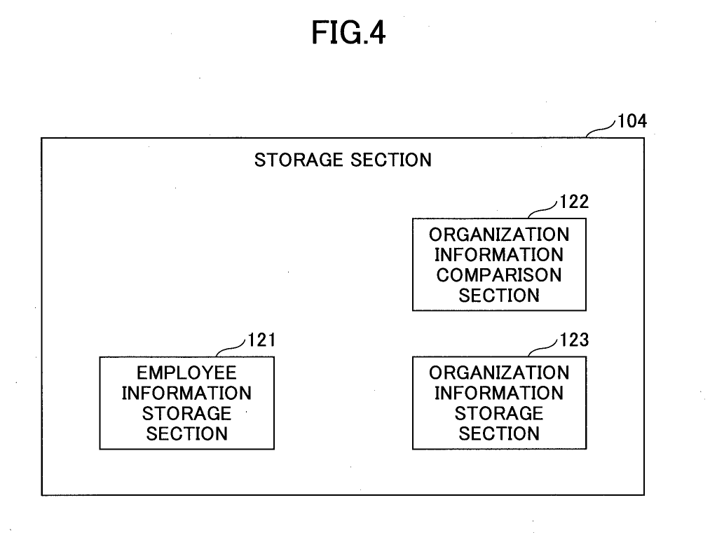

FIG. 4 is a detailed functional block diagram of the storage section 104 according to an embodiment of the present invention. As illustrated in FIG. 4, the storage section 104 includes an employee information storage section 121, an organization information comparison section 122, and an organization information storage section 123.

The employee information storage section 121 stores the name of the person and the title, which are included in the information received from the name card information acquisition section 102 or the external information acquisition section 103, in the employee information management table of FIG. 5. Further, the employee information storage section 121 stores the division code, which corresponds to the lowest division name (i.e., the division name to which the person belongs) from among a set of the division names which are received from the name card information acquisition section 102 or the external information acquisition section 103, in the employee information management table. Further, the employee information storage section 121 can identify the division code based on the organization information 153 of FIG. 7.

Further, the employee information storage section 121 stores data “YES” when the information is received from the name card information acquisition section 102, and stores data “NO” when the information is received from the external information acquisition section 103. Further, the employee information storage section 121 stores the date when the information is stored in the item “update date”.

When the name of the person, which is received from the name card information acquisition section 102 or the external information acquisition section 103, is not included in the employee information management table, the employee information storage section 121 generates a new entry in the employee information management table. Then, the employee information storage section 121 stores the name code, which differs from other name codes, the name, the division code, the title, the update date, and the data of the name card reception information, in the generated new entry. Further, the employee information storage section 121 generates the employee history information 152 of FIG. 6, and stores the update date and the division code, which are stored in the employee information management table, in the employee history information 152.

Next, a case is described where the employee information storage section 121 receives the information of the set of division names and the name and the title of persons, which are included in the external information of FIG. 10, from the external information acquisition section 103. The information includes the name “Jiro Suzuki”. The same name, however, is not included in the employee information management table of FIG. 5. Then, the employee information storage section 121 generates a new entry of “Jiro Suzuki”, and stores the name code “10012”, which is newly selected, the division code “102” corresponding to the division name “general affairs department”, the title “general manager”, the update date “2014/4/15”, and data “NO” of the name card reception information in the new entry. Similarly, the employee information storage section 121 stores the information of the newly added person in a new entry of the employee information management table.

On the other hand, when the name of the person, which is received from the name card information acquisition section 102 or the external information acquisition section 103, is included in the employee information management table, the employee information storage section 121 updates the name, the division code, the title, the update date, and the data of the name card reception information stored in the existing entry. Further, in a case where there exists the existing entry when the division code of the division which is newly received differs from the division code recorded in the employee information management table, the employee information storage section 121 updates the employee history information management table of FIG. 6. Specifically, the employee information storage section 121 generates a new entry in the employee history information management table; and stores the update date and the division code, which are newly stored in the employee information management table, in the newly generated entry.

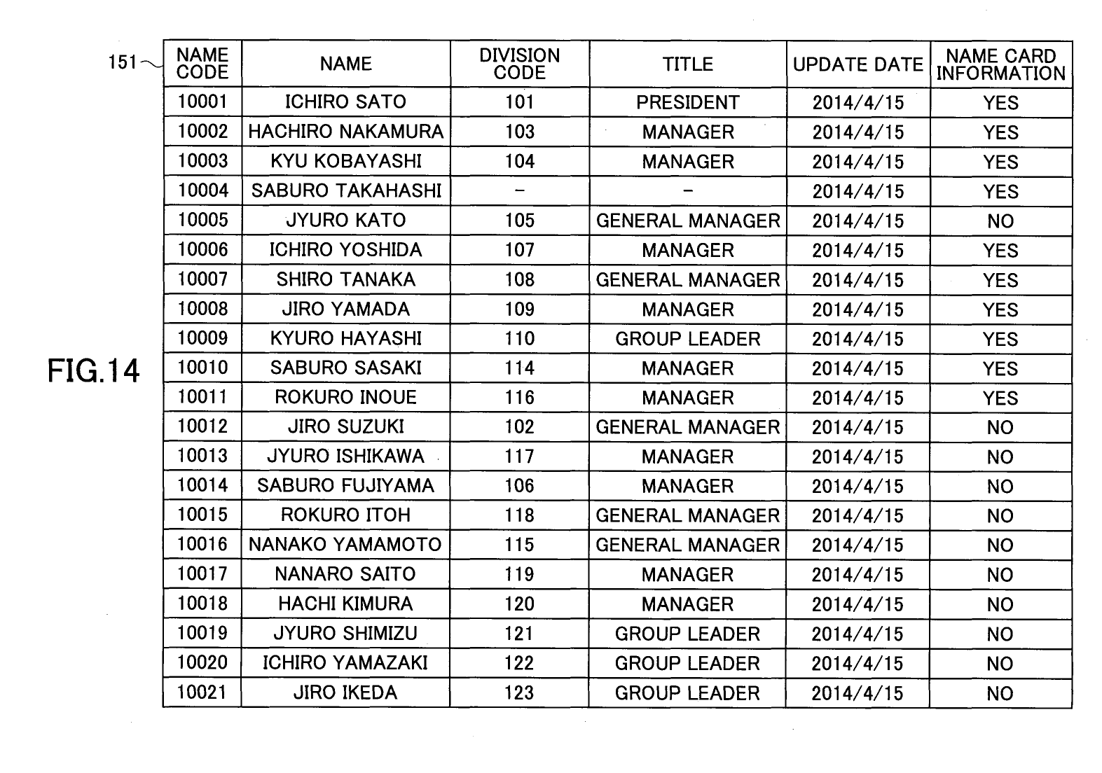

Next, a case is described where, for example, the employee information storage section 121 receives the information of a set of division names and the name and the title of persons, which is included in the external information of FIG. 10, from the external information acquisition section 103. The received information includes a name “Jyuro Kato”, and the same name is already included in the employee information management table of FIG. 5. Then, the employee information storage section 121 stores the division code “105” corresponding to the division name “corporate planning department”, the title “general manager”, the update date “2014/4/15”, and data “NO” of the name card reception information in the existing entry. Further, due to the change of the division code of “Jyuro Kato”, the employee information storage section 121 generates a new entry in the employee history information management table, and stores the update date “2014/4/15” and the division code “105” therein (not shown). FIG. 14 illustrates an example of the employee information management table which has been updated based on the external information of FIGS. 10 and 12.

The organization information comparison section 122 compares the organization's configuration described based on a set of one or more division names received from the name card information acquisition section 102 or the external information acquisition section 103 with the organization's configuration stored in the organization information management table of FIG. 7. When they are different from each other, the organization information comparison section 122 sends a report of the information indicating the difference to the organization information storage section 123.

A case is described where, for example, the organization information comparison section 122 receives the information of a set of division names, which is included in the external information of FIG. 10, from the external information acquisition section 103. The organization information comparison section 122 reads the organization information management table of FIG. 7, and forms an organization chart of FIG. 9. Further, the organization information comparison section 122 forms an organization chart of FIG. 11 based on the information received from the external information acquisition section 103. Further, the organization information comparison section 122 compares those two organization chart with each other, and identifies the difference.

In this case, the organization information comparison section 122 identifies that the “accounting section”, which is under the “general affairs department”, the “intellectual property department”, which is under the “president”, and the “second business section” and the “third business section”, which are under the “business department” are added to the organization chart of FIG. 9. The organization information comparison section 122 transmits the information, which is received from the external information acquisition section 103, to the organization information storage section 123, and instructs the organization information storage section 123 to store the information of the added divisions.

Similar to the above, another case is described where the organization information comparison section 122 receives the information of the set of division names, which is included in the external information of FIG. 12, from the external information acquisition section 103. In the case of FIG. 12, the organization information comparison section 122 forms an organization chart of FIG. 13. Here, in the organization chart of FIG. 13, divisions higher than the “first sales section” or the “second sales section” are missing. In this case, the organization information comparison section 122 compares only the organization structure of the “first sales section” or the “second sales section” or lower.

As a result, the organization information comparison section 122 identifies that the “second group”, which is under the “first sales section”, and the “third group” and the “fourth group”, which are under the “second sales section”, are added. The Organization information comparison section 122 transmits the information, which is received from the external information acquisition section 103, to the organization information storage section 123, and instructs the organization information storage section 123 to store the information of the added divisions.

Further, in the above description, the organization information comparison section 122 identifies the divisions which are added by the external information. The organization information comparison section 122, however, may identifies the division which has been removed. In this case, the organization information comparison section 122 instructs the organization information storage section 123 to remove the division. Further, the organization information comparison section 122 also compares with the existing organization structure when receiving the set of division names from the name card information acquisition section 102, and instructs the organization information storage section 123 to add or remove the division based on the change in the comparison result.

In the above descriptions, a comparison between the organization charts is described with reference to FIGS. 9, 11, and 13. Actually, the organization information comparison section 122 can detect a difference therebetween by using a known tree structure comparison algorithm.

In response to the instruction from the organization information comparison section 122, the organization information storage section 123 stores the changed organization information in the organization information management table of FIG. 7. Specifically, in response to an instruction from the organization information comparison section 122 to add, the organization information storage section 123 generates an entry of the organization information management table. Then, the organization information storage section 123 stores the division code of the division, which is selected so as not to overlap with any other division codes, the division code of the higher division which is higher than the division, the name of the division, and the current date in the generated entry. Further, in response to the instruction form the organization information comparison section 122 to remove, the organization information storage section 123 remove the corresponding entry from the organization information management table.

The achievement level calculation section 105 is realized mainly by the process performed by the CPU of FIG. 2, and calculates the number of name cards, the number of divisions, and the achievement level in the achievement level information 154. It is assumed that the division codes of the divisions to be calculated are set by the manager in advance. For example, in FIG. 8, as the division codes of the divisions to be calculated, the division codes “102”, “105”, “108”, and “115” are set.

First, the achievement level calculation section 105 reads the organization information management table of FIG. 7, and identifies all divisions that are under the division of the division code which is set in advance. Then, the achievement level calculation section 105 calculates the number of the identified divisions, and stores the number in the item “number of divisions” in the achievement level information management table of FIG. 8.

For example, in the case of the organization information management table of FIG. 7, the achievement level calculation section 105 searches for an entry where the division code “102” is to be set as the higher division code, and identifies the division codes “103” and “104”. Further, achievement level calculation section 105 searches for an entry where the division code “103” or “104” is to be set as the higher division code, and identifies no such divisions. As a result, the achievement level calculation section 105 identifies the division codes “102”, “103”, and “104”, and calculates the sum “three”. The achievement level calculation section 105 stores “three” as the data of the number of the divisions corresponding to the division code “102” in the achievement level information management table.

The achievement level calculation section 105 reads the employee information management table of FIG. 5, and calculates the number of entries where the data of thename card reception information of the employees who belong to the identified divisions are set to “YES”. Then, the achievement level calculation section 105 stores the total number of the calculated entries in the item “number of name cards” in the achievement level information management table of FIG. 8.

For example, in the case of the employee information management table of FIG. 6, the achievement level calculation section 105 searches the entries including the identified division codes “102”, “103”, and “104”, and counts the number of the entries where the data of the name card reception information are “YES”. Here, the achievement level calculation section 105 detects the entries where the data of the name codes are “10002” and “10003”, and further detects that the data of the name card reception information in those entries are set to “YES”. Therefore, the achievement level calculation section 105 stores the data “two” as the number of name cards in the item “number of name cards” in the achievement level information management table of FIG. 8.

Further, the achievement level calculation section 105 rounds a value which is calculated by dividing the calculated number of name cards by the number of divisions, and multiplies the rounded value by 100 to obtain a value of the achievement level. Then, the achievement level calculation section 105 stores the value in the achievement level information management table of FIG. 8 as the achievement level. The achievement level herein refers to a ratio of the number of acquired name cards to a scale of the identified divisions, and indicates the progress of sales activities.

For example, the achievement level calculation section 105 calculates a rounded value by dividing the number of name cards “2” corresponding to the division code “102” by the number of division “3” and multiplies the rounded value by 100 to obtain a value “66”. Then, the achievement level calculation section 105 stores the value “66” in the item “achievement level” in the achievement level information management table of FIG. 8. Note that the achievement level is not limited thereto, and may be calculated by any appropriate method. For example, the achievement level may be a ratio of the number of acquired name cards to the number of the employees belonging to the relevant division(s).

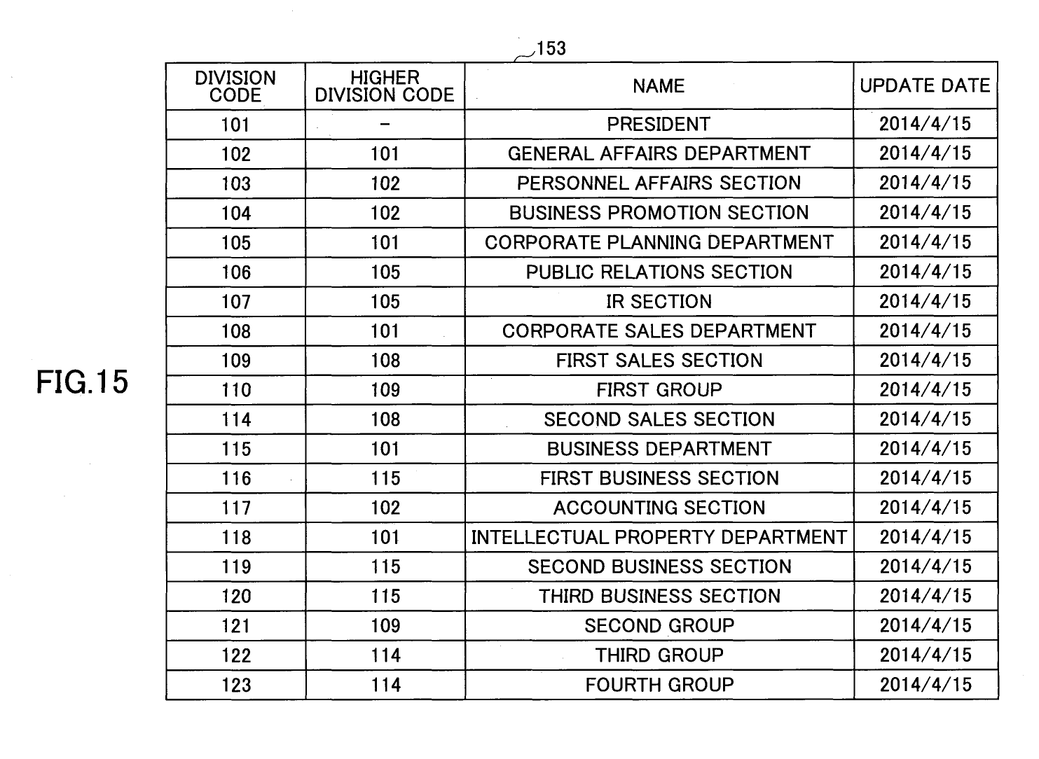

Further, the achievement level calculation section 105 may update the achievement level information 154 whenever the employee information 151 or the organization information 153 is updated. For example, as illustrated in FIGS. 14 and 15, the achievement level calculation section 105 can recalculate the number of name cards, the number of divisions, and the achievement level in response to the update of the employee information 151 or the organization information 153.

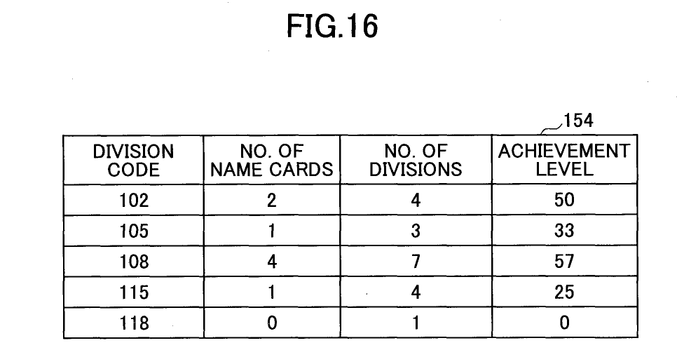

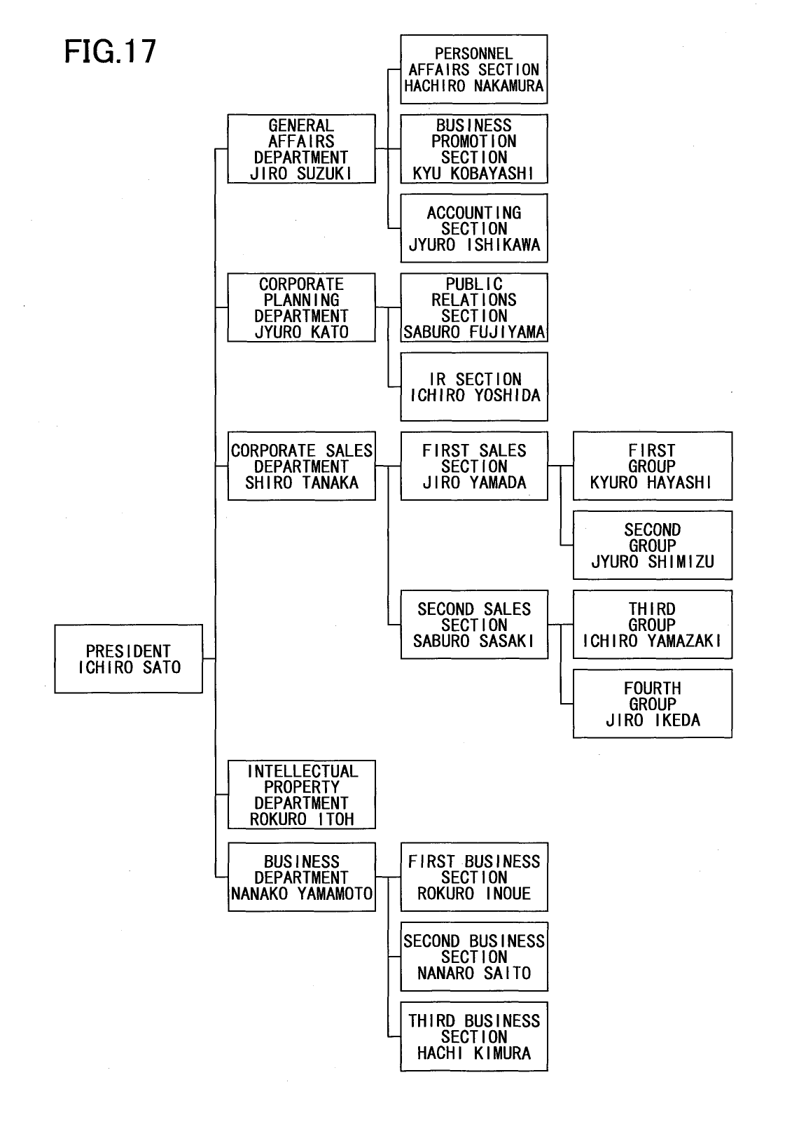

FIG. 16 illustrates the achievement level information management table, storing the achievement level information 154, calculated based on the employee information management table of FIG. 14 and the organization information management table of FIG. 15. As is already described, the employee information management table of FIG. 14 and the organization information management table of FIG. 15 include the information of added organizations (division) and employees based on the external information of FIGS. 10 and 12. Due to the information, the division code “117” (accounting section), which is under the division code “102” (general affairs department), is added and the number of the divisions in the achievement level information management table of FIG. 16 is increased to “4”.

On the other hand, the number of name cards in the achievement level information management table of FIG. 16 remains the same value “2”. This is because the number of data “YES” of the name card reception information in the employee information 151 is not increased (changed) even though the external information is added. As a result, the achievement level in the achievement level information management table of FIG. 16 is lowered to “50”.

The inquiry receiving section 106 is realized mainly by the process performed by the CPU 11 of FIG. 2, and receives an inquiry from a terminal of a user such as a person in charge of sales to display an information display screen to support sales activities. In addition to the inquiry, the inquiry receiving section 106 may further receive affiliation information of the user. Upon receipt of the inquiry, the inquiry receiving section 106 sends a report that the inquiry is received to the identification section 107.

The identification section 107 is realized mainly by the process performed by the CPU 11 of FIG. 2. Upon receipt of the inquiry from the inquiry receiving section 106, the identification section 107 refers to the achievement level information 154 stored in the memory section 101, and identifies the division code(s) having the achievement level which satisfies a predetermined condition. For example, the identification section 107 can identify the division code having the achievement level lower than or equal to a predetermined threshold value. The, identification section 107 transmits the identified division code to the output section 108.

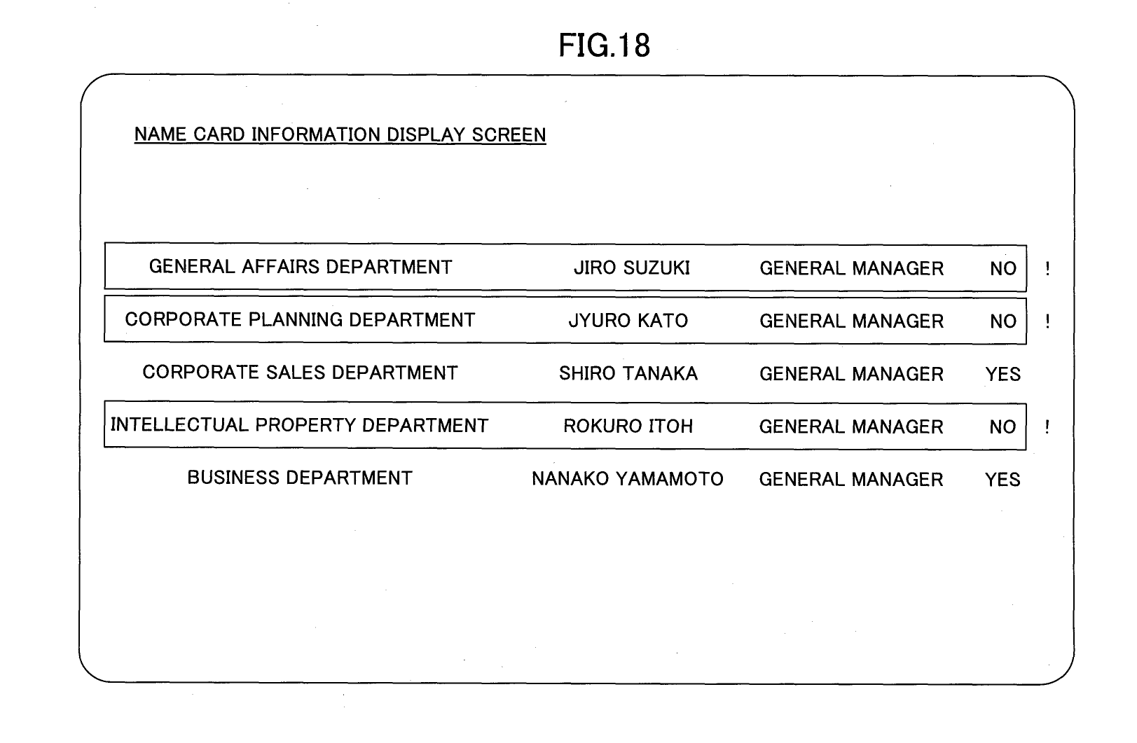

The output section 108 is realized mainly by the process performed by the CPU of FIG. 2, and outputs the information display screen to support sales activities to the terminal of the user who transmitted the inquiry. For example, the output section 108 can output the screens as illustrated in FIGS. 18 through 20 to the terminal of the user.

In the example of FIG. 18, the output section 108 can refer to the employee information 151, the organization information 153, and the achievement level information 154, and output the name of the division of the division code indicated in the achievement level information management table, the name of the responsible person of the division, and the name card reception information of the responsible person. Further, the output section 108 may highlight the item where the data of the name card reception information are “NO”. By doing this, the user can easily recognize that it is desired to conduct sales activities to the highlighted responsible person. Note that the example information of FIG. 18 is output based on the employee information 151, the organization information 153, and the achievement level information 154.

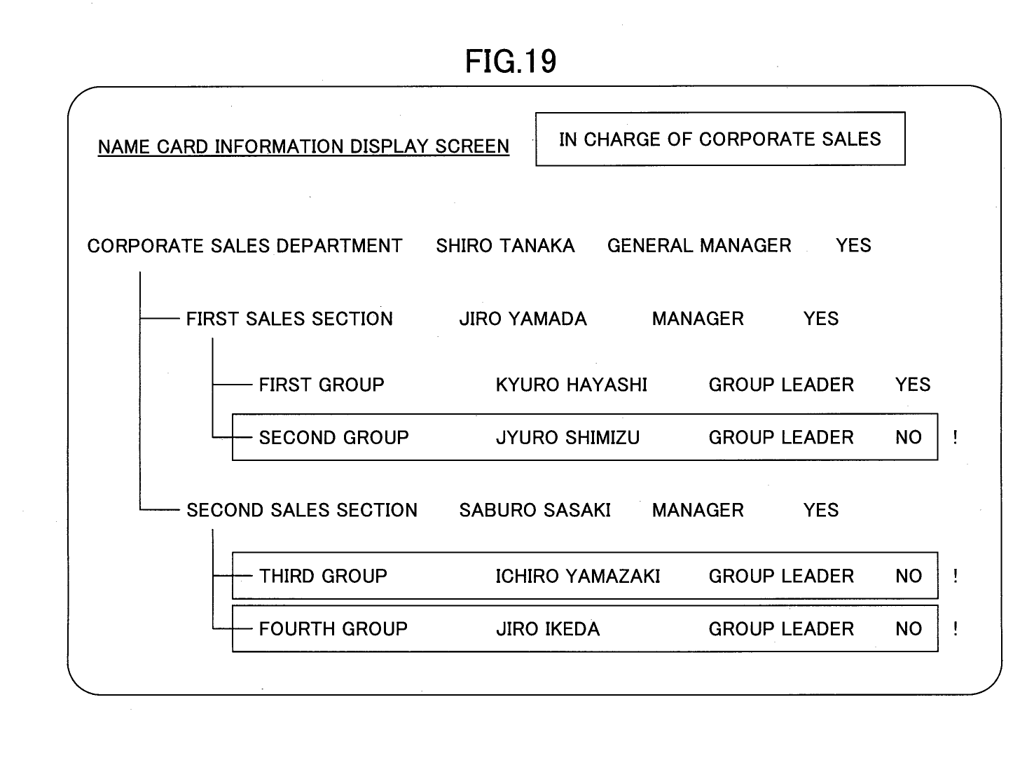

In the example of FIG. 19, in response to the affiliation of the user, the output section 108 controls the information of the divisions to be output. The output section 108 can output the information of the division which corresponds to the affiliation information of the user (e.g., “in charge of corporate sales”) received by the inquiry receiving section 106. In the example of FIG. 19, the affiliation information of the user is “in charge of corporate sales”, the output section 108 outputs the information of the corresponding “corporate sales department” and all divisions under the “corporate sales department” similar to FIG. 18. By doing this, it becomes possible for a user to effectively acquire information which corresponds to the user's affiliation.

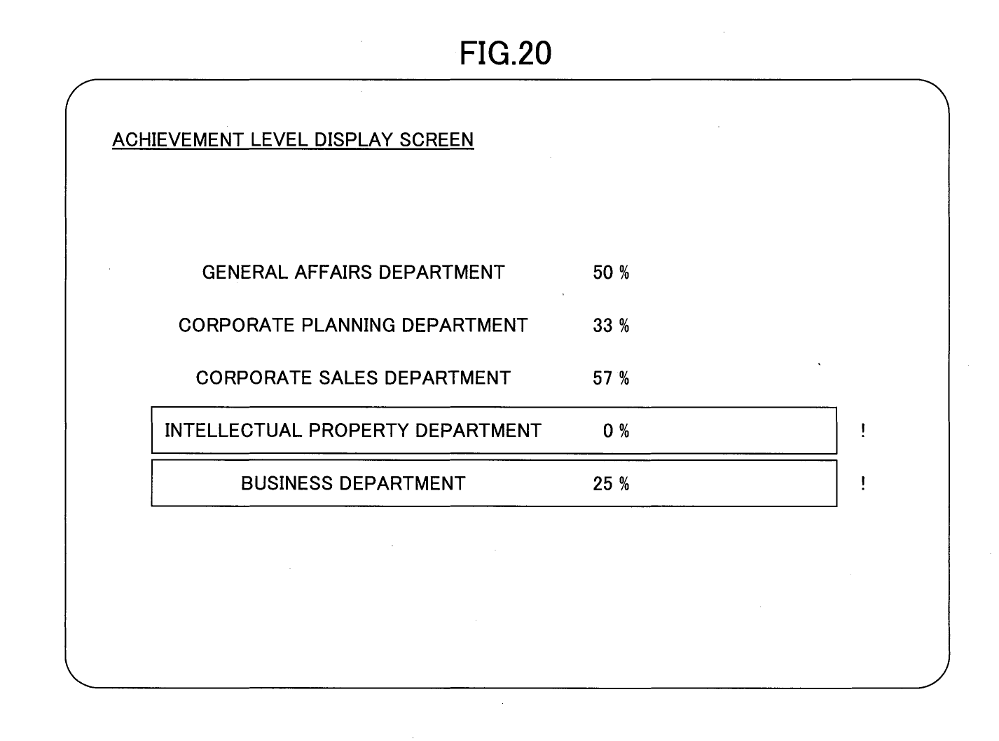

In the example of FIG. 20, the output section 108 can refer to the organization information 153 and the achievement level information 154, and output the name of the division code illustrated in the achievement level information management table and the achievement level of the division. Here, the output section 108 can highlight the division which is identified by the identification section 107, from among the divisions of the division codes indicated in the achievement level information management table. In the example of FIG. 20, the identification section 107 identifies the division codes having the achievement level less than or equal to 25, so that the output section 108 highlights two divisions, “intellectual property department” and “business department” which correspond to the division codes. By doing this, it becomes possible for the user to identify the division to which sufficient sales activities may not have been conducted.

### 4. Example Operations

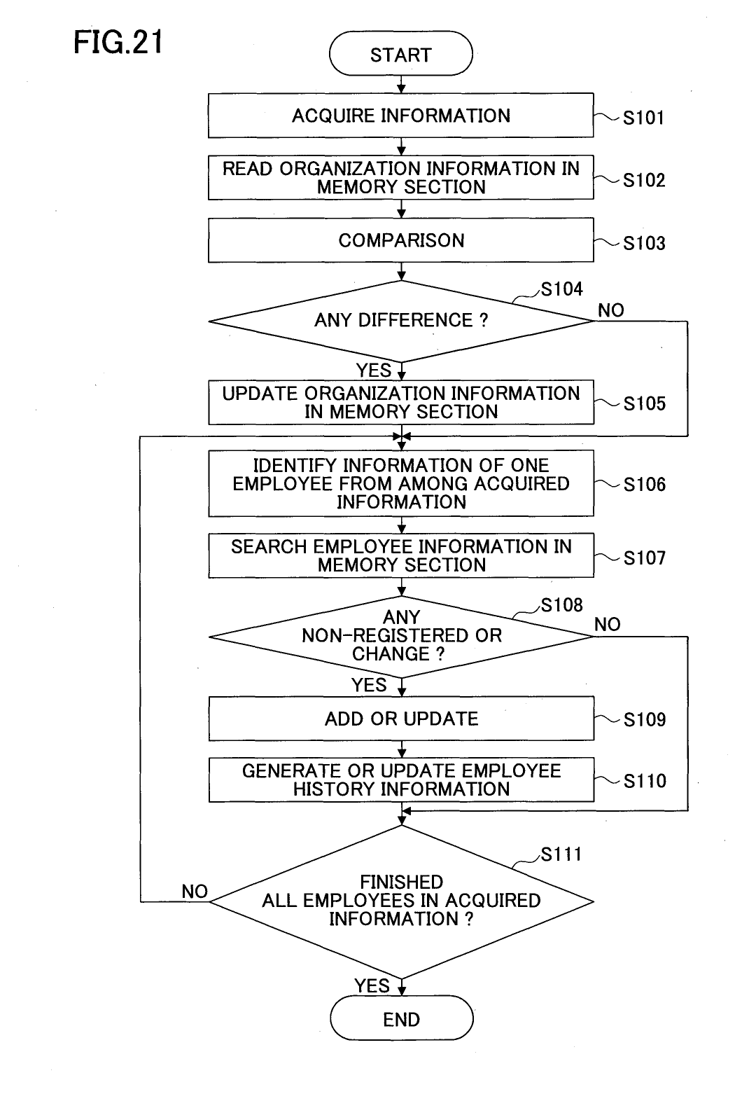

With reference to FIGS. 21 through 23, processes and specific operations of the information processing apparatus 100 according to an embodiment of the present invention are described.

### External Information Acquisition Process

FIG. 21 is a flowchart of the external information acquisition process performed by the information processing apparatus 100 according to an embodiment of the present invention. In the following description, it is assumed that the information processing apparatus 100 acquires the external information from the information providing apparatus 300.

The external information acquisition section 103 acquires the external information, which is transmitted from the transmission section 301 of the information providing apparatus 300, such as the information for investors and the personnel information (step S101). Next, the organization information comparison section 122 of the storage section 104 reads the organization information 153 stored in the memory section 101 (step S102). Then, the organization information comparison section 122 compares the organization's configuration described based on a set of one or more division names received from the external information acquisition section 103 with the organization's configuration stored in the organization information management table of FIG. 7 (step S103). Further, as described above, the organization's configuration can be expressed by tree structure, so the organization information comparison section 122 makes the comparison by using a known algorithm to compare tree structures.

Next, the organization information comparison section 122 determines whether those organization's configurations are different from each other (step S104). When determining that a difference therebetween exists (YES in step S104), the organization information storage section 123 updates the organization information 153 based on the difference (step S105). Otherwise, that is, when there is no difference, the process goes to step S106.

Next, the employee information storage section 121 identifies the information of one employee from among the information of one or more employees included in the external information received in step S102 (step S106). Next, the employee information storage section 121 searches the employee information, which is stored in the memory section 101, by using the name of the identified employee (step S107). Next, the employee information storage section 121 determines whether the information of the identified employee has not been registered and, when registered, further determines whether the information of the identified employee has been changed (step S108).

When determining that the information of the identified employee has not been registered or that the information of the identified employee has been changed when registered (YES in step S108), the employee information storage section 121 adds the information to the employee information 151 or updates the employee information 151 (step S109). Next, the employee information storage section 121 generates the employee history information management table or updates the employee history information 152 (step S110).

After that, the employee information storage section 121 determines whether the information of all employees included in the acquired information has been processed (step S111). When the information of all employees has been processed (YES in step S111), the process ends. Otherwise, the process goes back to step S106 to continue to perform the process for the rest of the employees.

In the above description, it is assumed that the information processing apparatus 100 has acquired the external information from the information providing apparatus 300. Note that the above description may also be applied when the information processing apparatus 100 acquires new name card information from the name card reading apparatus 200.

### Achievement Level Calculation Process

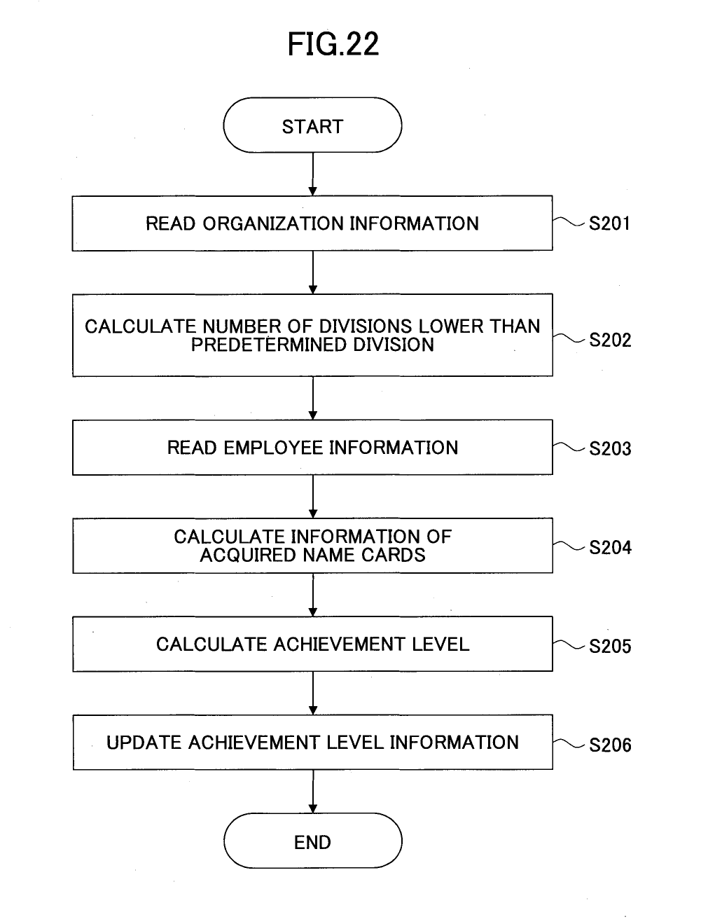

FIG. 22 is a flowchart of the achievement level calculation process performed by the information processing apparatus 100 according to an embodiment of the present invention. For example, the process may be executed whenever the employee information 151 or the organization information 153 is updated, or may be executed periodically or irregularly at the timing determined by the manager.

First, the achievement level calculation section 105 reads the achievement level information 154 stored in the memory section 101 (step S201). Next, the achievement level calculation section 105 identifies the division(s) which is lower than a predetermined division by referring to the organization information 153 stored in the memory section 101, and calculates the number of divisions corresponding to the identified divisions (step S202). Next, the achievement level calculation section 105 reads the employee information management table of FIG. 5 (step S203). Then, the achievement level calculation section 105 calculates the number of entries where the data of the name card reception information of the employees belonging to the identified divisions are “YES” (i.e., the number of acquired name cards) (step S204).

Next, the achievement level calculation section 105 calculate the achievement level by rounding a value calculated by dividing the number of name cards by the number of divisions and multiplying the rounded value by 100 on the identified division basis (step S205). Then, the achievement level calculation section 105 updates the achievement level information 154 based on the number of divisions, the number of name cards, and the achievement level calculated in steps S202, S204, and S205, respectively (step S206).

Specific Example of Operation

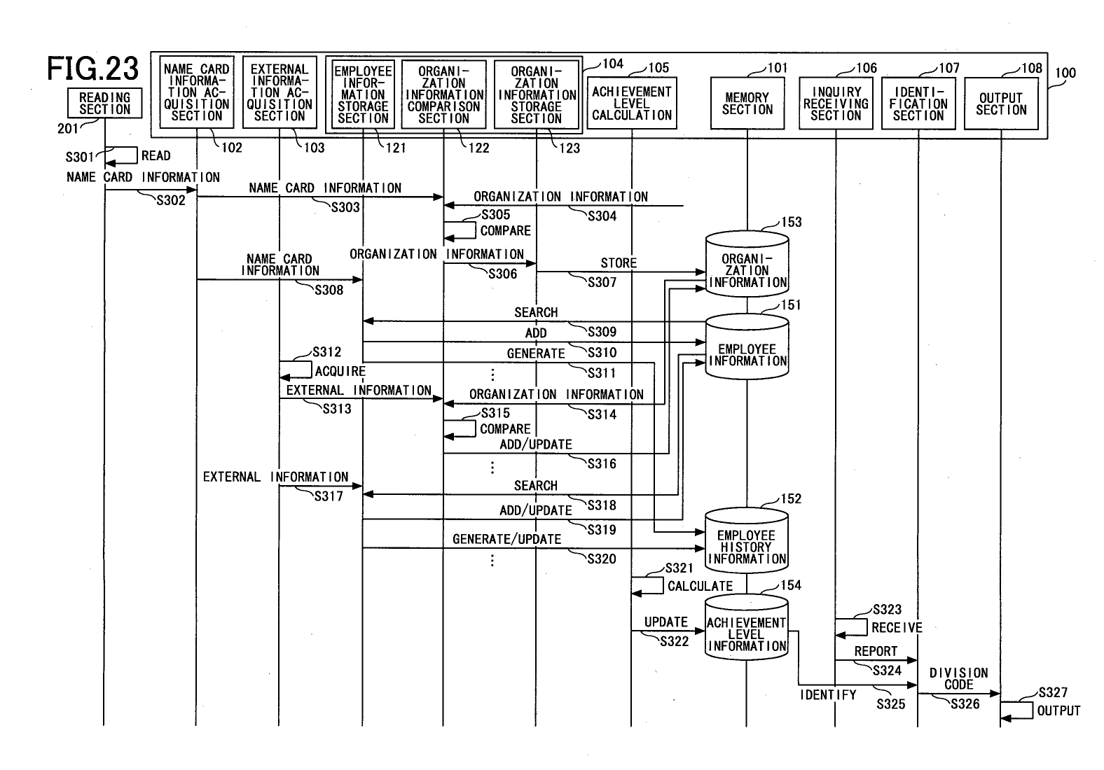

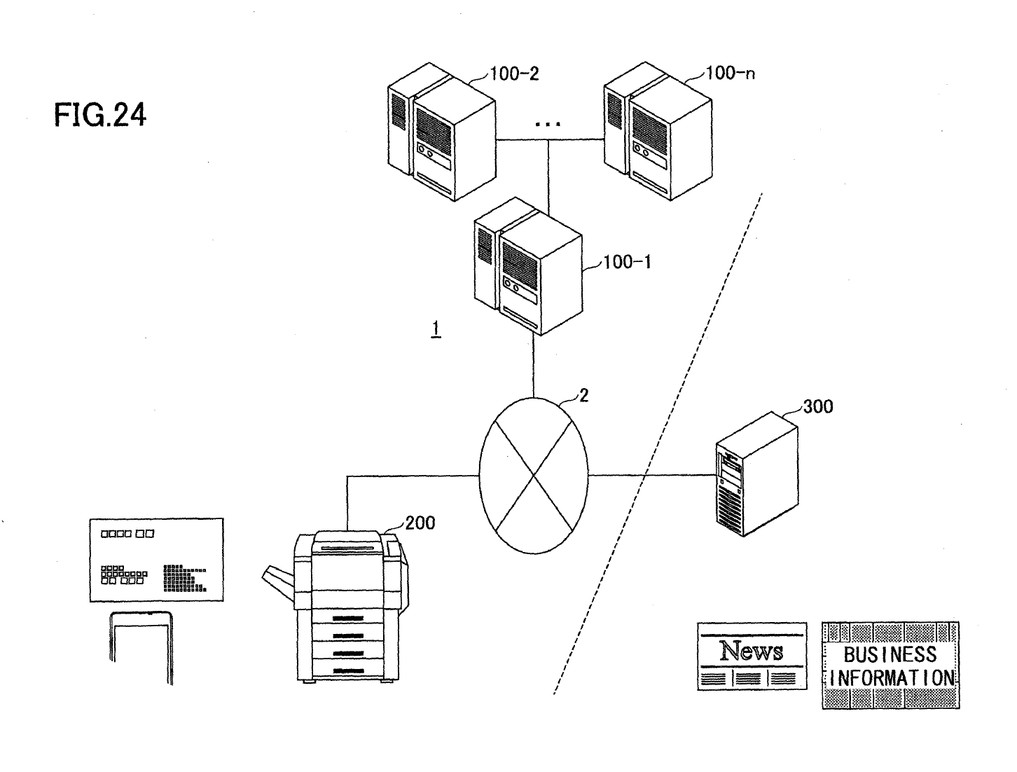

FIG. 23 is a sequence diagram of example operations performed by the information processing apparatus 100 according to an embodiment of the present invention. In the following example operation, it is assumed that no information is originally stored in the employee information 151 and the organization information 153.

First, the reading section 201 of the name card reading apparatus 200 reads the name card information (a set of one or more division names and name and title of the person) described in a name card by an OCR process (step S301). The name card information acquisition section 102 of the information processing apparatus 100 receives the name card information via the network 2 (step S302). Next, the name card information acquisition section 102 transmits the received name card information to the organization information comparison section 122 (step S303).

The organization information comparison section 122 reads the organization information 153 (step S304). Then, the organization information comparison section 122 compares the organization configured based on the name card information received in step S303 with the organization expressed based on the read organization information 153 (step S305). Specifically, the organization information comparison section 122 compares those organization expressed in tree structures by using a known algorithm to identify the difference therebetween. Here, the organization information 153 read in step S304 is null (includes no information). Therefore, the organization information comparison section 122 directly identifies the organization structure expressed based on the name card structure as the identified difference.

The information comparison section 122 transmits the organization information as the identified difference in step S305 to the organization information storage section 123 (step S306). The organization information storage section 123 stores the received difference information in the organization information 153 (step S307). Here, the organization information storage section 123 directly stores the organization structure expressed based on the name card information in the organization information 153 (step S307). FIG. 7 illustrates the organization information management table storing the organization information 153 as such.

Further, similar to the process in step S303, the employee information storage section 121 receives the name card information from the name card information acquisition section 102 (step S308). Next, the employee information storage section 121 searches the employee information 151, which is stored in the memory section 101, by using the name of the employee included in the name card information (step S309). Here, the employee information 151 is null. Therefore, the employee information storage section 121 adds the entry to store the name of the employee to the employee information management table (step S310). Further, the employee information storage section 121 generates the employee history information management table for the employee (step S311).

Then, the employee information storage section 121 repeats the processes of steps S309 through S311 for all employees included in the name card information. As a result, the employee information management table of FIG. 5 is generated.

After that, the external information acquisition section 103 acquires the external information which is transmitted from the information providing apparatus 300 or read by the name card reading apparatus 200 of FIG. 10 or 12 (step S312). Here, it is assumed that the external information acquisition section 103 acquires the external information from the information providing apparatus 300 of FIG. 10.

The external information acquisition section 103 transmits the external information to the organization information comparison section 122 (step S313). The organization information comparison section 122 having received the external information reads out the organization information management table of FIG. 7 (step S314). Then, the organization information comparison section 122 compares the organization's configuration indicated by the external information with the organization's configuration read from the organization information management table (step S315). Here, the organization's configuration indicated by the external information is as illustrated in FIG. 11, and the organization's configuration read from the organization information management table is as illustrated in FIG. 9. Therefore, the organization information comparison section 122 compares those tree structures and detects the following differences.

“accounting section” under “general affairs department” is added

“intellectual property department” under “president” is added

“second business section” and “third business section” under “business department” are added

As a result of the comparison, based on the detected differences, the organization information storage section 123 updates the organization information 153 (step S316). Specifically, the organization information storage section 123 generates new entries in the organization information management table with respect to the above added four divisions. Then, the organization information storage section 123 allocates new division codes “117”, “118”, “119”, and “120” to the divisions, and sets higher division codes “102” to “general affairs department”, “101” to “president”, and “115” to “business department”. Further, the organization information storage section 123 stores the names of the divisions “accounting section”, “intellectual property department”, “second business section”, and “third business section”, and sets the current date “2014/4/15” (acquisition date of external information) to the update date.

After that, the external information acquisition section 103 receives the external information of FIG. 12 provided by a paper medium from the name card reading apparatus 200, and performs the processes similar to those in steps S312 through S316. As a result, the organization information management table of FIG. 15 is generated.

Further, similar to the process in step S313, the employee information storage section 121 receives the name card information from the external information acquisition section 103 (step S317). Next, the employee information storage section 121 searches the employee information 151, which is stored in the memory section 101, by using the name of the employee included in the external information (step S318).

Then, the employee information storage section 121 generates a new entry with respect to an employee which does not exist in any of the entries of the employee information 151, and updates an entry based on new information with respect to an employee who already exists in the entry (step S319). For example, the entry corresponding to the name “Jiro Suzuki” of the employees included in the external information of FIG. 10 does not exist in the employee information management table of FIG. 5. Therefore, the employee information storage section 121 generates a new entry in the employee information management table. Then, the employee information storage section 121 stores the name code “10012”, the division code “102” indicating the general affairs department, the title “general manager” that can be acquired from the external information, the update date “2014/4/15” as the acquisition date of the external information, and the data “NO” of the name card reception information.

Next, the employee information storage section 121 generates a new employee history information management table for an employee who does not exist in any of the entries of the employee information management table (step S320). On the other hand, when the division code of an employee, which exists in the entry, is changed, the employee information storage section 121 updates the employee history information 152 with the new division code and the update date.

Next, the employee information storage section 121 repeats the processes of steps S318 through S320 for all employees included in the external information. As a result, the employee information management table of FIG. 14 is generated.

After that, the achievement level calculation section 105 reads the employee information management table of FIG. 14, the organization information management table of FIG. 15, and the achievement level information management table of FIG. 16, and calculates the number of name cards of the predetermined division(s), the number of divisions, and the achievement levels (step S321). Then, the achievement level calculation section 105 updates the achievement level information management table by using the calculated number of name cards, the number of divisions, and the achievement levels (step S322).

Next, the inquiry receiving section 106 receives an inquiry to display the information display screen to support sales activities from a terminal used by a user such as a person in charge of sales (step S323). The inquiry receiving section 106 reports the receipt of the inquiry to the identification section 107 (step S324). The identification section 107 reads the achievement level information management table of FIG. 16, and identifies the division codes whose achievement levels are less than or equal to 25 (step S325). Then, the identification section 107 transmits the identified division codes to the output section 108 (step S326). The output section 108 outputs a display screen, which displays the division names corresponding to the division codes included in the achievement level information management table of FIG. 16 and the achievement levels corresponding to the division codes, on the terminal of the user (step S327). FIG. 20 illustrates an example of such a display screen. Here, the output section 108 highlights the information corresponding to the identified division code.

### 5. Effect

As described above, the information processing apparatus 100 according to an embodiment can recognize the organization's configuration of the customer based on the name card information based on the received name cards. Further, the information processing apparatus 100 according to an embodiment can recognize the configuration similar to the actual organization's configuration of the customer based on the information acquired externally. As a result, it becomes possible for a person in charge of sales to know the name of the responsible person of the division clarified based on the information acquired externally, so that it becomes possible to conduct sales activities to the division which would not be known by using only the information based on name cards.

Further, the memory section 101 may further include a use information memory section to store the use of the information processing apparatus 100 and the use period of an image reading apparatus, so that the output section 108 can output charge information based on the number of read name card information, a predetermined unit price, and the use information of the information processing apparatus 100 and the image reading apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

The present application is based on and claims the benefit of priority of Japanese Patent Application Nos. 2014-114309 filed Jun. 2, 2014 and 2014-143238 filed Jul. 11, 2014, the entire contents of which are hereby incorporated herein by reference.

### DESCRIPTION OF THE REFERENCE NUMERALS

1: system
2: network
100: information processing apparatus
101: storage section
102: name card information acquisition section
103: external information acquisition section
104: storage section
105: achievement level calculation section
106: inquiry receiving section
107: identification section
108: output section
151: employee information
152: employee history information
153: organization information
154: achievement level information
200: name card, reading apparatus
300: information providing apparatus

### PRIOR ART DOCUMENTS

### Patent Document

[Patent Document 1] Japanese Laid-open Patent Publication No. 2003-296353

[Patent Document 2] Japanese Laid-open Patent Publication No. 2012-049906

1. An information processing apparatus included in an information processing system including a name card reading apparatus and the information processing apparatus which are connected to each other via a network, the information processing apparatus comprising:
a memory unit configured to store information of one or more divisions included in an organization and, information of persons belonging to the divisions acquired by reading name cards by the name card reading apparatus;
an acquisition unit configured to acquire information of persons belonging to respective divisions included in the organization from a medium other than the name cards;
an identification unit configured to identify information of the person not stored in the memory unit from the information of the persons acquired by the acquisition unit; and
an output unit configured to output the identified information of the person.

2. The information processing apparatus according to claim 1,
wherein the identification unit is configured to identify information of the person not stored in the memory unit from the information of the persons acquired by the acquisition unit and information of a division of the person.

3. The information processing apparatus according to claim 1,
wherein the output unit is configured to separately output information of the person or the division identified by the identification unit and information of a person or a division which is not identified by the identification unit from a predetermined one or more divisions.

4. The information processing apparatus according to claim 1,
wherein the output unit is configured to highlight the information of the person or the division identified by the identification unit.

5. The information processing apparatus according to claim 1, further comprising:
an achievement level calculation unit configured to calculate an achievement level indicating a ratio of a number of acquired name cards to a scale of predetermined divisions based on the number of divisions including a predetermined higher division and divisions under the higher division and name card reception information related to the persons belonging to the higher division or the divisions.

6. The information processing apparatus according to claim 1, further comprising:
an update unit configured to update the information of one or more divisions and the information of the persons stored in the memory unit;
wherein the acquisition unit is configured to further acquire information of one or more divisions included in the organization along with the information of the persons, and
wherein the update unit is configured to update the information of the divisions and the information of the persons stored in the memory unit based on the information of the divisions and the information of the persons acquired by the acquisition unit.

7. The information processing apparatus according to claim 1,
wherein the information of the person output by the output unit is the information of responsible persons of predetermined one or more divisions.

8. The information processing apparatus according to claim 1, further comprising:
a receiving unit configured to receive an inquiry from a user,
wherein the identification unit is configured to identify one or more divisions related to affiliation of the user.

9. The information processing apparatus according to claim 1,
wherein the medium other than the name cards includes a paper medium or an electronic medium storing information for investors and personnel information.

10. The information processing apparatus according to claim 1,
wherein when the medium other than the name cards is a paper medium, the acquisition unit is configured to acquire the information of divisions and the information of the persons by reading the paper medium by the name card reading apparatus.

11. The information processing apparatus according to claim 1,
wherein the memory unit is configured to further store information of use fee based on a use period of the information processing apparatus or a use period of the name card reading apparatus, and
wherein the output unit is configured to output the information of the use fee.

12. An information processing method executed by an information processing apparatus included in an information processing system including a name card reading apparatus and the information processing apparatus which are connected to each other via a network, the method comprising:
a storing step of storing information of one or more divisions included in an organization and information of persons belonging to the divisions acquired by reading name cards by the name card reading apparatus;
an acquisition step of acquiring information of persons belonging to respective divisions included in the organization from a medium other than the name cards;
an identification step of identifying information of the person not stored in the storing step from the information of the persons acquired in the acquisition step; and
an output step of outputting the identified information of the person.

13. An information processing system comprising:
a name card reading apparatus; and
an information processing apparatus connected to the name card reading apparatus via a network,
wherein the name card reading apparatus includes
a reading unit configured to read a name card, and
wherein the information processing apparatus includes
a memory unit configured to store information of one or more divisions included in an organization and information of persons belonging to the divisions acquired by reading the name cards by the reading unit;
an acquisition unit configured to acquire information of persons belonging to respective divisions included in the organization from a medium other than the name cards;
an identification unit configured to identify information of the person who is not stored in the memory unit from the information of the persons acquired by the acquisition unit; and
an output unit configured to output the identified information of the person.
